(19) United States
(12) Patent Application Publication
(10) Pub. No.: US 2011/0316707 A1
(43) Pub. Date: Dec. 29, 2011

(54) REMOTE MONITORING SYSTEM FOR MULTIPLE STEAM TRAPS

(75) Inventors: Michael H. Gaines, Kalamazoo, MI (US); William R. Horton, Centreville, MI (US)

(73) Assignee: ARMSTRONG GLOBAL HOLDINGS, INC., Stuart, FL (US)

(21) Appl. No.: 12/824,326

(22) Filed: Jun. 28, 2010

(51) Int. Cl. G08B 17/10

(52) U.S. Cl. 340/632

(57) ABSTRACT

A system for remotely monitoring multiple steam traps includes a plurality of steam traps, each including a monitor comprising one or more sensors for sensing selected operating conditions of the steam trap, and a programmable controller operatively connected to receive the outputs of each of the sensors, convert the sensor outputs into one or more data signals corresponding to the sensed conditions, and transmit the data signals, directly or indirectly, to a central computer. The central computer includes a receiver and logic for evaluating the data received from the monitors to thereby monitor the condition of the steam traps. At least some of the steam trap monitors also include a local receiver adapted to receive data signals transmitted from other steam trap monitors and re-transmit the received data so that remote monitors otherwise outside the direct receiving range of the central computer are received by the central computer.

### TECHNICAL FIELD

This invention relates to a system for remotely monitoring the operating status of a plurality of steam traps or pressure relief valves utilized in fluid-handling installations.

### BACKGROUND

Fluid-handling installations, such as systems employing steam lines, are common in factories, refineries, and other industrial and commercial facilities. These fluid-handling systems often employ steam traps and/or pressure relief valves, which are connected directly or indirectly, to fluid flow lines to monitor and/or affect the operation of the fluid-handling system.

For example, steam traps are commonly installed in process steam lines to separate condensed steam, or “condensate,” from the steam without allowing the steam to escape. The separated condensate has been recycled back through condensate return lines to the boiler for conversion back to steam. Some installations may contain several hundred or more steam traps. To promote efficient operation of the steam traps (and the steam lines) some type of monitoring or inspection is required to detect malfunctioning traps so that the traps, or the steam conditions causing the malfunction, can be corrected.

Prior methods of monitoring steam traps included incorporating signal lights on the traps indicative of the process condition in the traps. These systems require visual inspection of each of the steam traps in the manufacturing facility to properly monitor the steam traps. Without consistent and comprehensive visual inspection, malfunctioning traps may go undetected, thereby decreasing the operational efficiency of the steam lines.

Another known method of monitoring steam traps is to provide a hard-wired system that interconnects each of the traps to one or more centrally located control stations for receiving and storing data concerning the process conditions of each of the connected steam traps. However, it can be appreciated that in larger installations, the work required to hard wire hundreds of steam traps is very expensive.

In addition, hard-wired systems are difficult to retrofit in existing installations, and, as well, difficult to modify when steam traps are moved or added to the installation.

A method and system for monitoring steam traps using wireless signaling is disclosed in U.S. Pat. Nos. 5,992,436 and 6,145,529, each issued to Hellman, et al., the disclosure of which is hereby incorporated by reference in its entirety. As shown in FIG. 1, this wireless steam trap monitoring system employs a plurality of steam traps 1 each including a monitor capable of transmitting radio frequency (RF) signals responsive to sensed process conditions in the steam trap, and receiving the transmitted signals with a central receiver 2. In this system, the signals from at least some of the steam traps 1 are received and retransmitted by repeaters 3 positioned between the steam traps 1 and the receiver 2. In this manner, a single central receiver can receive signal data from many steam trap monitors which are physically situated in a physically expansive installation, even where individual steam traps are obstructed from (see 4), or are located outside of the range of, the central receiver, so long as a repeater is located within range of each steam trap monitor, and within range of another repeater or the central receiver. The disadvantage of this system, however, is that it requires the installation of additional components—the repeaters—which adds cost to the system. Also, the repeaters are separately powered by a wired electrical connection, and, in certain industrial installations, must be provided with an explosion-proof housing, each requiring additional installation costs.

### SUMMARY

The present invention provides a system for remotely monitoring steam traps and/or pressure relief valves in fluid-handling installations. The disclosed system includes a plurality of steam traps, each including a monitor comprising one or more sensors, including at least one acoustic sensor, for sensing selected operating conditions of the steam trap, a sensor controller operatively connected to receive the outputs of each of the sensors, convert the sensor outputs into one or more data signals corresponding to the sensed conditions, and provide data uniquely identifying the monitor (and steam trap) to which the sensor controller is connected.

Each steam trap monitor also includes a data signal controller and a transmitter adapted to transmit the data signals generated by the sensor controller.

At least some of the steam trap monitors also include a local receiver adapted to receive data signals transmitted from other steam trap monitors within receiving range.

The disclosed system further includes at least one central computer including a receiver for receiving signals transmitted from the steam trap monitors and evaluating the data received from the monitors to thereby monitor the condition of the steam traps and/or the steam lines.

In one disclosed embodiment, each of the steam trap monitors includes a local receiver for receiving data signals from other steam trap monitors within receiving range.

In an alternative embodiment, some, but not all, of the steam trap monitors include a local receiver. In this embodiment, the steam trap monitors with local receivers are strategically placed in the system to provide the capability to transmit (and re-transmit) data signals from all steam traps (including those without local receivers) to the central computer.

The system may also be employed to monitor pressure relief valves, or other operational and/or safety devices utilized in steam lines or other fluid handling applications. As used herein, fluid is intended to mean and include any flowable mass or material including liquids, gases, and liquid-gas combinations.

### BRIEF DESCRIPTION OF THE DRAWINGS

Embodiments of the present disclosure described herein are recited with particularity in the appended claims. However, other features will become more apparent, and the embodiments may be best understood by referring to the following detailed description in conjunction with the accompanying drawings, in which:

FIG. 1 is a schematic elevational view of a prior art steam trap monitoring system;

FIG. 2 is a schematic elevational view of one embodiment of a steam trap monitoring system of the present invention;

FIG. 3 is an elevational view of a steam trap monitor which may be used in the system of the present invention;

FIG. 4 is an elevational view of a pressure relief valve monitor which may be used in the system of the present invention;

FIG. 5 is a schematic view, partially cut away, of a steam trap monitor utilized in the system of the present invention; and

FIG. 6 is a flow diagram of a network management algorithm utilized by the system in the illustrated embodiment.

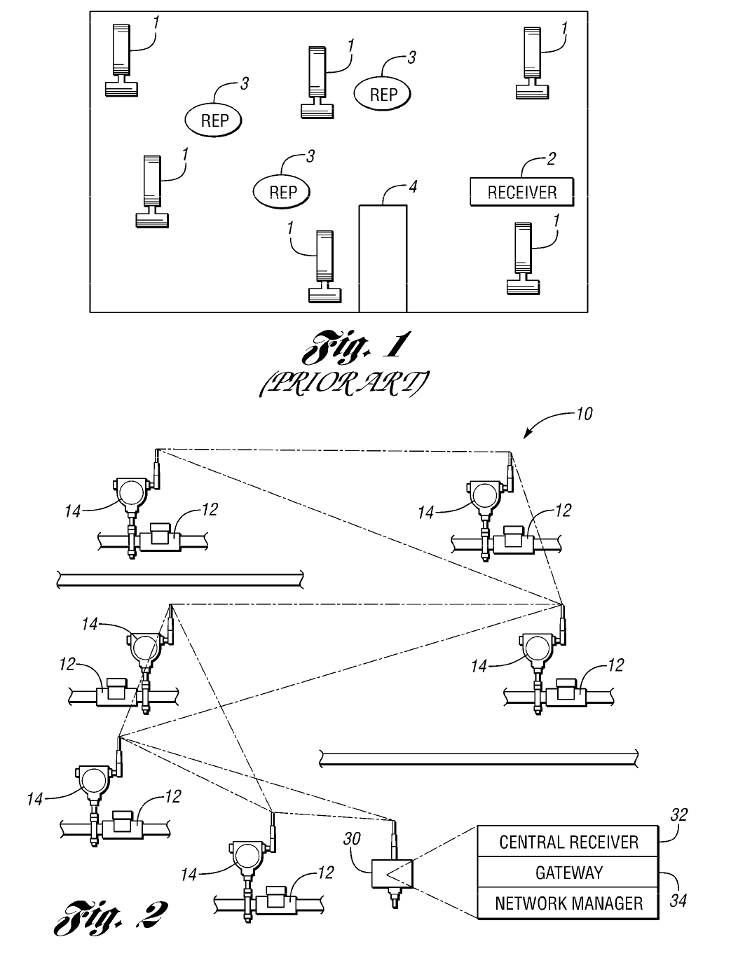

### DETAILED DESCRIPTION

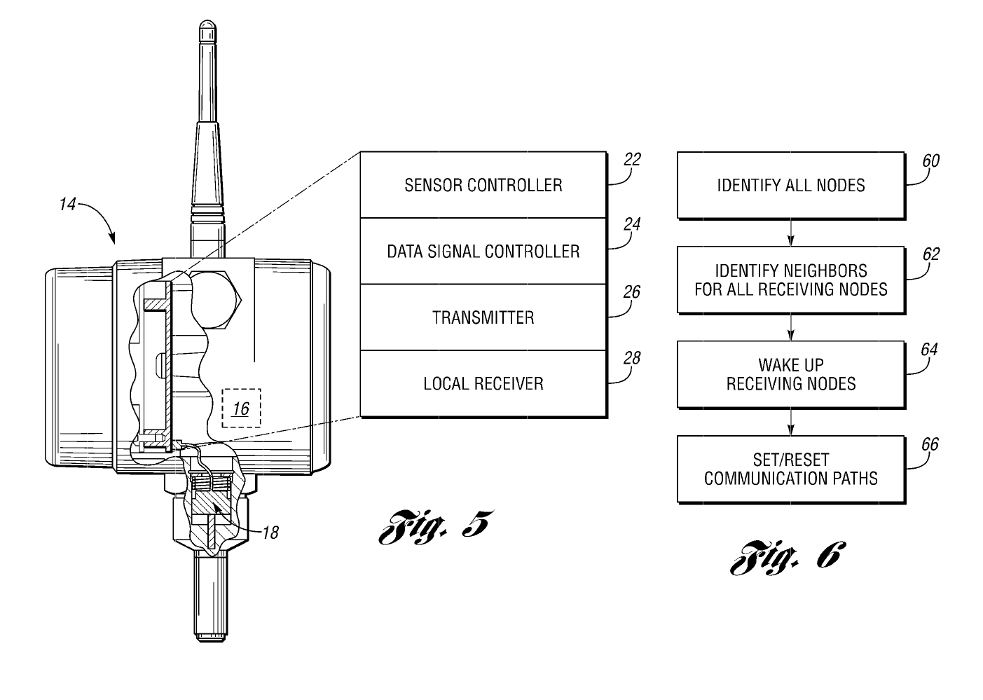

The representative embodiments used in the illustrations relate generally to multi-station monitoring systems wherein each station includes a steam trap or pressure relief valve, mounted directly or indirectly in a fluid-handling system, such as a steam line. As those of ordinary skill in the art will understand, various features of the embodiments illustrated and described with reference to any one of FIGS. 2-6 may be combined with features illustrated in one or more other Figures to produce embodiments that are may not be explicitly illustrated or described. The combinations of features illustrated provide representative embodiments for typical applications. However, various combinations and modifications of the features consistent with the teachings of the present disclosure may be desired for particular applications or implementations.

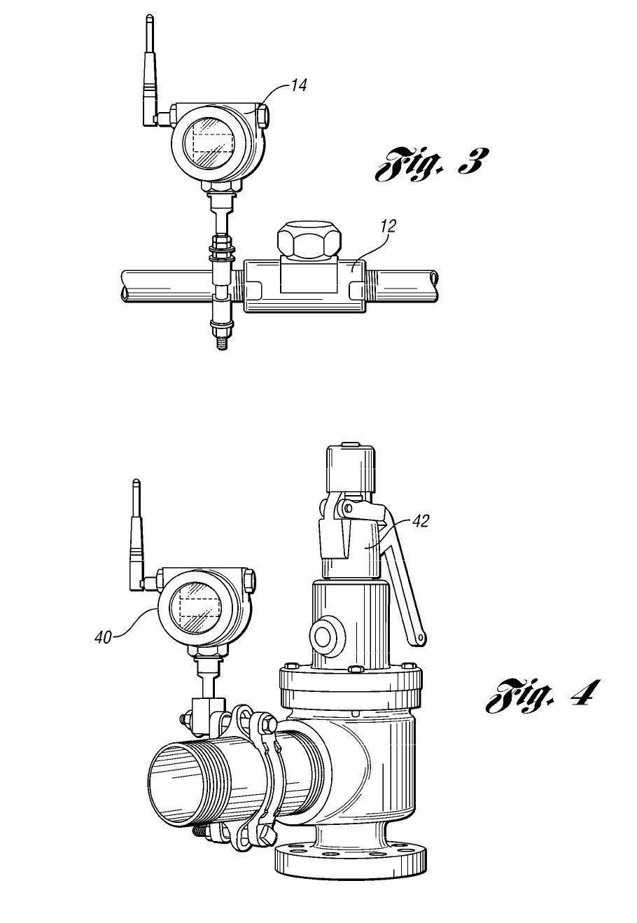

Referring to FIGS. 2-5, the illustrated system 10 includes a plurality of steam traps 12, each operably connected to a monitor 14. The illustrated steam trap 12 is generally conventional and well known in the art, although it is to be understood that systems utilizing the present invention may incorporate other types of steam traps, as well as pressure relief valves. The steam trap 12 is connected to a live steam line (not shown) which supplies steam into the steam trap 12. The steam trap 12 is also connected to a condensate return line (not shown) to direct the condensate back to the steam generator, such as a boiler (not shown). A typical steam trap monitor, and its associated steam trap, are shown in FIG. 3. Various other details which may be included in steam trap 12 are disclosed in U.S. Pat. No. 7,246,036, issued to Cheskaty, et. al., the disclosure of which is hereby incorporated by reference in its entirety.

It will be appreciated that the system 10 may be utilized to monitor pressure relief valves or other valves, or safety or operational devices used in fluid handling situations. A typical pressure relief valve monitor 40, and its associated pressure relief valve 42, are shown in FIG. 4.

The monitor 14 includes one or more sensors 16 for sensing selected operating conditions of the steam trap 12. In the illustrated embodiment, the sensors 16 include an acoustic sensor 18 and a temperature sensor 20. However, it will be appreciated by those skilled in the art that additional sensors may be included as desired. For example, in embodiments of the system including pressure relief valves, an acoustic sensor, and/or position, pressure, or leakage sensors may also be included in the monitor for sensing those selected characteristics in the pressure relief valve. The monitor 14 can be any suitable enclosure for encasing the sensing equipment, controllers, transmitter, and local receiver required for operation of the system.

In the illustrated system 10, a Model No. SMUTF40-TR15B peizo-electric air transducer is employed as the acoustic sensor, available from Steiner & Martins, Inc. of Miami, Fla. However, other types of acoustic sensors may also be employed as dictated by the specific physical characteristics of the installation.

One or more temperature sensors, such as a “Therm-O-Disc” Style # 470562, part no. 9RT1H602 thermistor, manufactured by Therm-O-Disc, Inc. of Mansfield, Ohio, may also be included in the monitor.

Positioned within the monitor 14 is a microprocessor-based sensor controller 22, which can be any suitable programmable device capable of controlling the gathering, storage and dissemination of process condition data. The sensor controller 22 is operatively connected to receive as inputs, the outputs of each of the sensors, and convert the received inputs into one or more data signals (such as radio frequency signals) corresponding to the outputs of the sensors. A suitable microprocessor for the sensor controller is Motorola part no. 18F46K20, available from Motorola, Inc. of Schaumburg, Ill. In the illustrated embodiment, the sensor controller 22 is programmed to analyze the sensed inputs and develop one of four status indicators for the associated steam trap 12. In the illustrated embodiment, the four-valued status indicator generated from each analysis of the received sensor input, represents “good,” “blow-through,” “cold,” or “loss of signal” conditions at the steam trap.

It will be appreciated that any combination of one or more of the received sensor inputs may be utilized to develop the status indicator, depending upon the particular industrial application for which the system is utilized. Also, it will be appreciated that the system may alternatively be designed such that the sensor controller 22 performs no analysis of the sensed signals, but instead simply receives and transmits data corresponding directly to the sensed conditions to the central computer. Thus, the data analysis may be performed either by the sensor controller 22 in the monitor 14, by the central computer 30, or by each of the sensor controller and the central computer in some desired combination.

Each monitor 14 also includes a data signal controller 24 and a microprocessor-based radio frequency transmitter 26. The data signal controller 24 receives input from the sensor controller 22, and causes the transmitter 26 to transmit an appropriate radio frequency signal responsive to the sensed process conditions in the form of (a) the data signals generated by the sensor controller, as well as (b) data uniquely identifying the particular monitor/steam trap to which the sensor controller 22 is connected. The data signal controller 24 may be any suitable device that is programmable and is capable of receiving the output from the sensor controller 22. A suitable data signal controller is included in an M2510 mote module, available from Dust Networks of Hayward, Calif. The transmitter 26 can be any suitable device for transmitting an appropriate radio frequency signal responsive to the condition of the steam trap 12. A preferred transmitter is also included in the M2510 mote module, available from Dust Networks.

It should be noted that, although the illustrated embodiment shows the sensor controller 22, signal controller 24, and the transmitter 26 as separate components, one or more programmable microprocessor(s), not shown, may be used in combination to control the sensing signal generating, and transmitting functions. In the illustrated embodiment, the data signal controller 24, the transmitter 26, and the receiver (28, described below), are each included in a single microprocessor-based module.

In the illustrated system, each monitor 14 may also include a local receiver 28 adapted to receive data signals transmitted from other steam trap monitors within receiving range. The signal controller 24 also includes (a) logic for analyzing each of the signals received by the local receiver 28 to determine whether the signals were transmitted from another recognized steam trap monitor in the system, and, as well, (b) logic for re-transmitting of the signals received by the local receiver 28 when instructed to do so by the gateway manager 34 in the central computer 30. Thus, each steam trap monitor 14 which includes a local receiver 28 is suitably programmed to transmit the data corresponding to the particular monitor to which the receiver 20 is attached, as well as the data received by other specified monitors within range of the receiver 28 of this monitor. In the illustrated embodiment, the local receiver is included in the M2510 mote module, available from Dust Networks of Hayward, Calif.

The system also includes a central computer 30 including a central receiver 32 adapted to receive data signals from all steam trap monitors transmitting such signals within the receiving range of the central receiver 32. The central receiver 32 can be any suitable device for picking up the RF signals. It is to be understood that the characteristics of the receiver 32 must be matched to those of the transmitters 26 to provide a proper communications link and optimal RF performance. A suitable receiver for the central computer is the M2140 board, available from Dust Networks of Hayward, Calif. Dust Networks part no. 805-0018 Rev 3 may be employed as a network gateway 34 to control and coordinate communications for the mesh network of monitors and the central computer 30.

The central computer 30 may be suitably programmed to receive the data signals as described above and analyze the signals to associate each transmitted signal with a particular steam trap, analyze the sensed conditions at that steam trap, and record and/or report (or display) the data (or additional data directly or indirectly developed from the sensed conditions at each steam trap) to an operator in the desired manner. For example, the central computer is typically adapted to provide alarms or other indications when steam traps are determined to be malfunctioning.

FIG. 6 illustrates the logic employed in one embodiment of the system 10 to manage the transmission and receipt of data signals in the mesh network. In one embodiment, a microprocessor in the network gateway 34 associated with the central computer is suitably programmed to perform this network managing function. As shown in box 60, the system identifies all of the monitors 14 (also referred to as “nodes”) in the system network. Each node is given a unique identification number. At box 62 the system 10 identifies, for each receiving node, each of the neighboring nodes that are within range of that receiving node.

The system (at 64) also sets the operating parameters for each of the nodes 14. In particular specific “waking time” and “sleep time” are established. During the waking time, which is typically from about 100 to about 200 milliseconds (but may vary as dictated by each system application), each node becomes active, processing sensor data received from its own sensors, transmitting the data signals corresponding to the processed sensor data, and re-transmitting any data signals received from other nodes 14 which have been identified as valid nodes in the system to be recognized by re-transmitting node. At the end of waking time, the node then shuts down, or sleeps, for a specified period of time, typically about 5 minutes to 1 hour for steam trap systems, and about 30 seconds to 2 minutes for pressure relief valve systems.

It will be appreciated that the system may be programmed to dynamically adjust the “waking time” and “sleep time” of the monitor depending on the sensed operating conditions for each particular monitor. For example, in a steam trap system, the normal sleep time may be set to about 1 hour, but adjusted to a dramatically shorter time when a “blow” condition is detected at a steam trap. In this manner, the monitor can report sensed data more frequently when system conditions dictate that closer monitoring of conditions is desirable.

At 66, the system 10 sets one or more communication paths for each of the nodes to optimize communication and insure that all nodes' messages are transmitted efficiently through the network. It will be appreciated that the message transmission path for a particular node 14 may change depending upon the number and location of nodes in the network, as well as transient operating conditions encountered during normal operation of the system 10. The communication paths are typically set by the central computer by providing each node which has a local receiver (the receiving node) with a list of any neighboring node(s) which the receiving node should recognize as a source of data signals which, if received by the receiving node, should be re-transmitted. The receiving node then forwards the data signals, either directly to the central receiver, or to another receiver node in closer proximity to the central receiver, which has similarly been authorized to recognize received transmissions from the first-mentioned receiving node, and again re-transmit the data signals.

In one embodiment, the optimal pathways are determined by the gateway in the central computer 30 primarily on the basis of signal strengths of each of the nodes. Of course, other criteria may also be considered in setting and/or changing the communication paths within the mesh network.

In the illustrated embodiment, the “WirelessHART” network communication protocol is employed to facilitate the communication among steam trap monitors and the central computer, although other protocols employing mesh, star and combined mesh and star topologies may alternatively be employed for this purpose.

In the embodiment of FIG. 2, each of the monitors includes a local receiver and is, thus, a receiving and re-transmitting node. It will be appreciated that by including receivers in each of the steam trap monitors 14, the communication network may be easily expanded when additional monitors are introduced to the system 10. In addition, a greater number of alternative communication pathways may be developed by the gateway in the central computer to optimize communication in the event of disruption of existing communication pathways. The system may thus be utilized to monitor a large number of steam traps physically located in an expansive location that is larger than the receiving range of the central receiver 32, since each of the local receivers 28 in each steam trap monitor 14 receives and, in turn, retransmits data signals received from other monitors 14 within its range.

In the embodiment of FIG. 6, each monitor in the system 10 actively determines the process conditions and establishes the status of the steam traps within a period of active time, and remains inactive for a period of inactive time. The data signal controller is programmed to look at or sense the status of the steam trap as reported by sensors. This sensing or sampling by the data signal controller occurs periodically, such as perhaps once every half second. The transmitter is similarly controlled to periodically transmit (only during waking periods) data signals indicative of the status of the associated steam trap, as well as forwarding data signals received by the local receiver, either directly to the receiver at the central computer, or to other neighboring monitors.

In this embodiment, the gateway manager, located in the central computer, periodically instructs each of the steam trap monitors data signal controllers as to (1) when and how long to wake up, (2) how long to become inactive, (3) and over what path (s) on the network to transmit the data signals. The transmitting of the RF signals can be accomplished during the same waking period as the period during which the sensor data is acquired, or during a period different from the period of the sampling by the data signal controller. In one embodiment, the period between successive steps of transmitting signals is within the range of from about 0.5 to about 300 seconds. However, the signal from the transmitter is transmitted immediately upon detection of a condition outside the programmed limits.

Each monitor 14 also includes at least one battery to provide power to the components within the monitoring device. Any suitably sized long-life battery may be used. In the illustrated embodiment, 3.6 Volt lithium battery, model no. TLH-5920, available from Tadiran U.S. Battery Division of Lake Success, N.Y. As previously discussed, the sensor controller, transmitter, and receiver may be programmed to operate periodically for short periods of time, to limit the amount of current drawn from the battery. This periodic operation prolongs battery life, thereby reducing the amount of service (and battery replacement) required by the system monitors.

Another aspect of the disclosed system may include the ability of the monitoring system to remotely monitor the steam trap 12 to learn the individual operational characteristics of the steam trap 12. In this embodiment, the programmable sensor controller may be programmed with an algorithm which tests or senses various process conditions at the initial start-up and then throughout the operation of the steam trap.

It will be appreciated that the sensor controller, the data signal controller, and the central computer may be programmed to include other specific known capabilities suitable for the particular steam trap or pressure relief valve installation, including those disclosed in previously referenced U.S. Pat. No. 7,246,036, as well as disclosed in U.S. Pat. No. 7,203,626, issued to Quake, et. al., which is also incorporated herein for that purpose.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for monitoring the operating conditions of a plurality of steam traps, the system comprising:
a monitor associated with each steam trap, each monitor including one or more sensors, including at least one acoustic sensor, for sensing selected operating conditions of the associated steam traps, and a transmitter; and
a computer including a central receiver for receiving the data signals transmitted from the monitors and evaluating the data received from the monitors,
wherein one or more of the monitors also includes a local receiver adapted to receive data signals transmitted from other monitors within receiving range, and the computer includes a data communication network control including logic for receiving the data signals either directly or indirectly from all of the monitors, by designating a specified set of one or more neighboring monitors for one or more of the monitors having local receivers, whereby the one or more of the receiving monitors recognizes the data signals received by one or more of the designated neighboring monitors and re-transmits the data signals received from such recognized neighbor for receipt by (1) another receiving monitor or (2) the central receiver.

2. The system of claim 1 wherein some, but not all, of the monitors include a local receiver.

3. The system of claim 1 wherein all of the monitors include a local receiver.

4. The system of claim 1 wherein some, but not all, of the monitors which include a local receiver receives a specified set of one or more neighboring monitors for which such monitor recognizes and re-transmits data signals transmitted by such neighboring monitors.

5. The system of claim 1 wherein all of the monitors which include a local receiver receives a specified set of one or more neighboring monitors for which such monitor recognizes and re-transmits data signals transmitted by such neighboring monitors.

6. The system of claim 1 wherein all of the monitors include a local receiver and some, but not all, of the monitors receives a specified set of one or more neighboring monitors for which such monitor recognizes and re-transmits data signals transmitted by such neighboring monitors.

7. A system for monitoring the operating conditions of a plurality of pressure relief valves, the system comprising:
a monitor associated with each pressure relief valve, each monitor including one or more sensors, including at least one acoustic sensor, for sensing selected operating conditions of the associated pressure relief valves, and a transmitter; and
a computer including a central receiver for receiving the data signals transmitted from the monitors and evaluating the data received from the monitors,
wherein one or more of the monitors also includes a local receiver adapted to receive data signals transmitted from other monitors within receiving range, and the computer includes a data communication network control including logic for receiving the data signals either directly or indirectly from all of the monitors, by designating a specified set of one or more neighboring monitors for one or more of the monitors having local receivers, whereby the one or more of the receiving monitors recognizes the data signals received by one or more of the designated neighboring monitors and re-transmits the data signals received from such recognized neighbor for receipt by (1) another receiving monitor or (2) the central receiver.

8. The system of claim 7 wherein some, but not all, of the monitors include a local receiver.

9. The system of claim 7 wherein all of the monitors include a local receiver.

10. The system of claim 7 wherein some, but not all, of the monitors which include a local receiver receives a specified set of one or more neighboring monitors for which such monitor recognizes and re-transmits data signals transmitted by such neighboring monitors.

11. The system of claim 7 wherein all of the monitors which include a local receiver receives a specified set of one or more neighboring monitors for which such monitor recognizes and re-transmits data signals transmitted by such neighboring monitors.

12. The system of claim 7 wherein all of the monitors include a local receiver and some, but not all, of the monitors receives a specified set of one or more neighboring monitors for which such monitor recognizes and re-transmits data signals transmitted by such neighboring monitors.

13. A system for remotely monitoring the operating conditions of a plurality of steam traps including:
a plurality of steam traps,
a monitor associated with each steam trap, each monitor comprising:
one or more sensors, including at least one acoustic sensor, for sensing selected operating conditions of the associated steam trap,
a transmitter,
a local receiver adapted to receive data signals transmitted from other steam trap monitors within receiving range,
a control operatively connected to the sensors, transmitter, and local receiver, including logic for receiving as inputs, the outputs of each of the sensors, converting the received inputs into one or more data signals including data corresponding to the outputs of the sensors and data uniquely identifying the monitor to which the sensor controller is connected, and transmitting the data signals generated by the sensor controller and the data signals received by the local receiver; and
a computer including a central receiver and logic for receiving signals transmitted from the steam trap monitors and evaluating the data received from the monitors.

14. A steam trap monitor for use with a steam trap in a system for remotely monitoring the operating conditions of a plurality of steam traps, the steam trap monitor including:
one or more sensors, including at least one acoustic sensor, for sensing selected operating conditions of the associated steam trap,
a sensor controller operatively connected to receive as inputs, the outputs of each of the sensors, and convert the received inputs into one or more data signals including data corresponding to the outputs of the sensors and data uniquely identifying the monitor to which the sensor controller is connected,
a local receiver adapted to receive data signals transmitted from other steam trap monitors within receiving range, and
a transmitter adapted to transmit the data signals generated by the sensor controller and the data signals received by the local receiver.

15. A pressure relief valve monitor for use with a pressure relief valve in a system for remotely monitoring the operating conditions of a plurality of pressure relief valves, the pressure relief valve monitor including:
one or more sensors, including at least one acoustic sensor, for sensing selected operating conditions of the associated pressure relief valve,
a sensor controller operatively connected to receive as inputs, the outputs of each of the sensors, and convert the received inputs into one or more data signals including data corresponding to the outputs of the sensors and data uniquely identifying the monitor to which the sensor controller is connected,
a local receiver adapted to receive data signals transmitted from other pressure relief valve monitors within receiving range, and
a transmitter adapted to transmit the data signals generated by the sensor controller and the data signals received by the local receiver.
